(19) United States
(12) Patent Application Publication
(10) Pub. No.: US 2005/0241777 A1
(43) Pub. Date: Nov. 3, 2005

(54) Cornice frame with foam inset

(76) Inventor: Anna M. Boehm, Barnhart, MO (US)

Correspondence Address: Paul M. Denk;Ste. 170, 763 S. New Ballas Road, St. Louis, MO, 63141, US

(21) Appl. No.: 11/109,597

(22) Filed: Apr. 19, 2005

Related U.S. Application Data
(60) Provisional application No. 60/566,006, filed on Apr. 28, 2004.

(51) Int. Cl. E06B 9/00

(52) U.S. Cl. 160/38

(57) ABSTRACT

The cornice frame readily installs upon a wall and allows many fabric coverings to decorate the top of a window. The cornice frame has a wooden, two wooden side struts at each end, a foam board, in the header, locking hardware for joining the struts and the header, and mounting hardware connecting the struts to an adjacent wall. Upon the inside of the struts and the header, a groove runs substantially along the perimeter in which foam cord fits to secure fabric. The locking hardware operates as interlocking male and female fittings. The mounting hardware has a male fitting that fits a female fitting upon a wall. Plastic flange fasteners with a washer and a screw secure decorations to the foam board. Homeowners can assemble and install the cornice frame with minimal tools in a short time.

### CROSS REFERENCE TO RELATED APPLICATION

This nonprovisional patent application claims priority to the provisional patent application having Ser. No. 60/566,006, which was filed on Apr. 28, 2004.

### BACKGROUND OF THE INVENTION

The cornice frame relates to window decorations in general and more specifically to an improved frame for a cornice above a window. A unique aspect of the present cornice frame is a foam board within a header.

People install valances, or cornices near windows for decoration. Homeowners decorate windows to fit a theme of a room that pleases the eye. A homeowner coordinates the decorations of a window with the fashions in the room: linen, furniture, and wall treatment. Cornices attach to the wall above a window and visually separate the window from the ceiling in a room. Cornices also reflect the taste of a homeowner. From time to time, people install or change cornices to follow fashion. A homeowner installs a cornice upon a wall and decorative items upon the cornice. When fashions change, a homeowner removes the cornice from the wall and changes the decorations upon the cornice. Present models of cornice have proven labor intensive and limited in fabric choices.

The present art overcomes the limitations of the prior art. That is, the art of the present invention, a cornice frame, assembles readily and provides for prompt changing of fabric with quick demounting of the frame from a wall, and fabric from a frame.

The difficulty in providing a cornice frame is shown by the operation of a typical frame. A homeowner chooses a location for a frame and the frame has a central member and two side members. The homeowner attaches brackets to the wall near a window with screws. The homeowner then slips fabric around and along the central member to decorate it and connects the side members to the ends of the central member with bolts. Connecting the side members to the brackets with bolts, an existing frame takes position above a window. To change a cornice, a homeowner demounts the existing frame from the brackets by undoing the bolts and then removes the side members to change the fabric. Homeowners require some mechanical skill to mount, use, demount, and change cornices on existing frames. The prior art reveals many different frames and methods to assemble them.

The patent to Ashby, U.S. Pat. No. 4,828,002, shows a cornice covering the headrail of a window treatment such as Venetian blinds. This patent has a front panel and two side panels. This patent discloses slots on the back of the front panel for mounting clips and the slots may support foam cords. However, this patent has separate end pieces to complete the ninety degree connection of a front to a side panel and mounting clips that attach the front panel to the headrail.

The patent to Attal, U.S. Pat. No. 5,042,548, shows a cornice again covering a headrail above a window. This patent has front and side panels, and slots on the back of the front panel. This patent discloses slots on the front panel again and the snap fitting of parts. Unlike the present invention, this patent has a front panel with top and bottom flanges, no foam in the front panel interior, covers on the end plates, and dovetailed corner pieces.

The patent to John, U.S. Pat. No. 5,259,687, shows a narrow member that has flanges for a valance in the same vein as Attal's '548 patent. As before, this patent has a front panel supported on two sides to the wall. In contrast, this patent uses a projecting rib to connect valance parts, has a wider upper flange and corner pieces, and lacks foam.

The patent to Badalamenti, U.S. Pat. No. 5,505,245, shows a foam cornice fitting over an existing valance bar. Similar to the present invention, this patent discloses a cornice of foam construction with slots in the back to tuck in fabric. This patent discloses foam having fabric secured in slots while the present invention has the slots in the header panel. However, in this patent, the foam does not have a frame surrounding the cornice and the foam rests upon a separate valance.

The patent to Smiley, U.S. Pat. No. 5,967,213, describes a window cornice with a taut fabric covering. The present invention has a similar front section and two side sections and fabric upon the sections. However, this invention emphasizes fabric held taught by clips and elastic while relying upon a separate valance bar, corner pieces, and support strips to reinforce front and side section connections.

The patent to Santoro, U.S. Pat. No. 6,152,204, shows a foam board that has a fabric cover with decorations. The foam board serves as the header and has multiple lengths, and has pin on fabric as decoration. Unlike the present invention, the foam board has no frame about its perimeter, no end members connected to the foam board, no longitudinal grooves in the foam board, and more intricate side brackets.

The present invention overcomes the difficulties of installation, assembly, and decoration encountered in existing frames.

### SUMMARY OF THE INVENTION

The cornice frame readily installs upon a wall and allows many fabric coverings to decorate the top of a window. The cornice frame has a header, two side struts at each end of the header, a foam board, locking hardware, and mounting hardware. The header has an open center section filled with a foam board. Upon the inside of the struts and the header, a groove runs generally along the perimeter. Pieces of foam cord fit within the groove to secure fabric to the header. The locking hardware joins the struts to the header by pins grasped by cylinders. The mounting hardware attaches to the struts opposite the locking hardware. A male fitting joins the top of a strut and fits a female fitting upon a wall. Fasteners with a washer and a screw secure the decorative items to the foam board.

In use, a homeowner installs the mounting hardware then the locking hardware. Next, the homeowner places the struts at the locking hardware and draws the struts towards the header. The foam board is attached to the header and fabric is already applied over the header and struts. With pieces of foam cord in grooves, the homeowner secures the fabric to the invention, then the invention to a wall.

### BRIEF DESCRIPTION OF THE DRAWINGS

FIG. 1 shows an isometric view of the interior of the preferred embodiment of the cornice frame constructed in accordance with the principles of the present invention;

FIG. 2 shows a view of the interior of the upright struts of the present invention;

FIG. 3 shows an unassembled view of the interior of the upright header and accessories of the present invention;

FIG. 4A shows a sectional view of a decorated header of the present invention taken along line 4A-4A of FIG. 3; and, FIG. 4B shows a detailed view of the cord securing the fabric within a groove of the present invention.

### DESCRIPTION OF THE PREFERRED EMBODIMENT

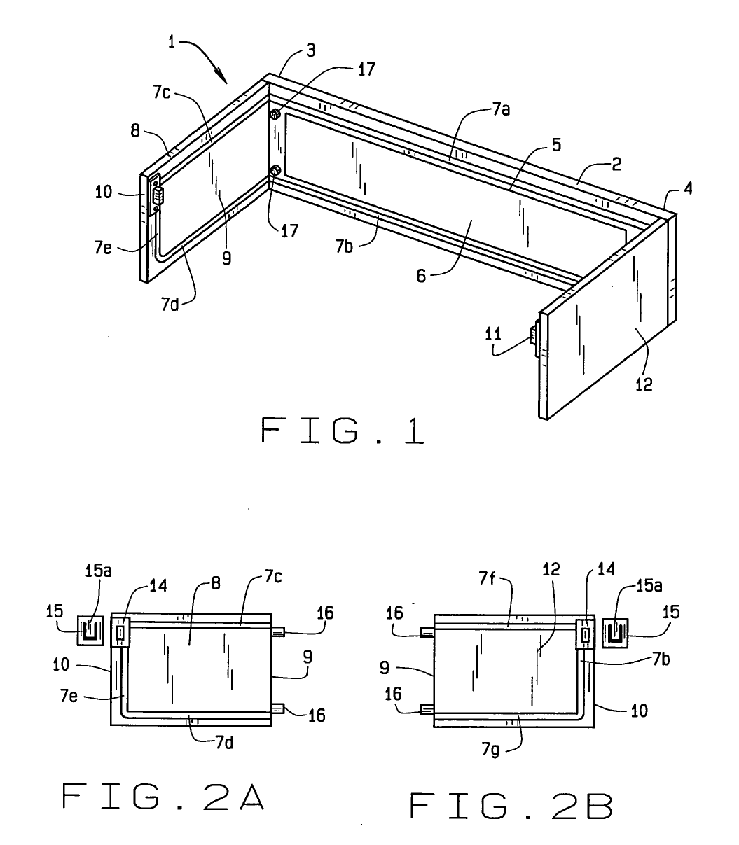

The present art overcomes the prior art limitations by providing a foam board within a header over which fabric is secured by pieces of foam cord. Turning to FIG. 1, the preferred embodiment of the cornice frame 1 is shown in a view of the interior. The header 2 has a generally rectangular shape oriented upright. That is, the thickness of the header 2 is parallel to the horizontal. The header 2 has a left end 3 and an opposite right end. Between the left end 3 and the right end, the header 2 has an opening 5 filled with a core or a foam board 6. The foam board 6 can be accessed from both sides. The left end 3 and the right end 4 each have two spaced apart female locking fittings 17 as locking hardware. Parallel to the foam board 6, the header 2 has two spaced apart and mutually parallel grooves 7a, 7b.

At the left end 3, a left strut 8 joins to the header 2. The left strut 8 has a generally rectangular shape, a front end 9 and an opposite back end 10, and an upright orientation to match the header 2. Parallel to the longitudinal axis, the left strut 8 has two spaced apart and parallel grooves 7c, 7d. Opposite the joint to the header 2, the left strut 8 has a groove 7e spanning between the two parallel grooves 7c, 7d and a male mounting pin 14 upon the back end 10 serving as means to mount 11 the present invention upon a wall. The grooves 7c, 7d, 7e are proximate to the perimeter of the left strut 8. The two parallel grooves 7c, 7d in the left strut 8 align with the two grooves 7a, b in the header 2. The male mounting pin 14 attaches to the left strut 8 opposite the header 2 and extends perpendicular to the surface of the strut. The male mounting pin 14 defines the top of the present invention.

Opposite from the left strut 8, a right strut 12 joins to the header 2 at the right end. The right strut 12 has a generally rectangular shape, a front end 9 and a back end 10, and an upright orientation to match the header 2. Opposite the joint to the header 2, the right strut 12 has a male mounting pin 14 as a part of the means to mount 11 the present invention 1 upon a wall. The male mounting pin 14 attaches to the right strut 12 opposite the header 2 and extends perpendicular to the surface of the strut. With the present invention assembled, the mounting pins 16 of the left strut 8 and the right strut 12 are coaxial. As in the left strut 8, the male mounting pin 14 defines the top of the present invention. Preferably, the header 2, the left strut 8, and the right strut 12 are made of yellow pine 14.

Moving to FIG. 2, the left strut 8 has a generally rectangular shape and orientation to match the header 2. Parallel to the longitudinal axis, the left strut 8 has two spaced apart and mutually parallel grooves 7c, 7d. Opposite the joint to the header 2, the left strut 8 has a groove 7e spanning between the two parallel grooves 7c, 7d across the back end 10. The grooves 7c, 7d, 7e are proximate to the perimeter of the left strut 8. The two grooves 7c, 7d in the left strut 8 align with the two grooves 7a, 7b in the header 2. At the joint with the header 2, the left strut 8 has two spaced apart male locking pins 16. The male locking pins 16 mate with the female locking fittings 17 in the left end 3 of the header 2. Opposite the male locking pins 16, the left strut 8 has a male mounting pin 14 located at the top of the present invention. The male mounting pin 14 extends perpendicular to the surface of the strut and generally towards the interior of the present invention. The male mounting pin 14 engages a female mounting bracket 15 attached to a wall above a window [not shown] as the mounting means 11. The female mounting bracket 15 has a slot 15A to receive the male mounting pin 16 temporarily.

Opposite the left strut 8, the cornice frame 1 has a right strut 12. The right strut 12 has a generally rectangular shape and orientation to match the header 2. Parallel to the longitudinal axis, the right strut 12 has two spaced apart and parallel grooves 7f, 7g. Opposite the joint to the header 2, the right strut 12 has a groove 7h spanning between the two parallel grooves 7f, 7g. The grooves 7f, 7g are proximate to the perimeter of the right strut 12. The two grooves 7f, 7g in the right strut 12 align with the two grooves 7b, 7b in the header 2. At the joint with the header 2, the right strut 12 has two spaced apart male locking pins 16. The locking pins 16 mate with the female locking fittings 17 in the right end 4 of the header 2. Opposite the locking pins 16, the right strut 12 has a male mounting pin 14 located at the top of the present invention. The male mounting pin 14 extends perpendicular to the surface of the strut and generally towards the interior of the present invention 1. The male mounting pin 14 engages a female mounting bracket 15 attached to a wall above a window [not shown]. The female mounting bracket 15 has a slot to receive the male mounting pin 14 temporarily. The right strut 12 is a mirror image of the left strut 8.

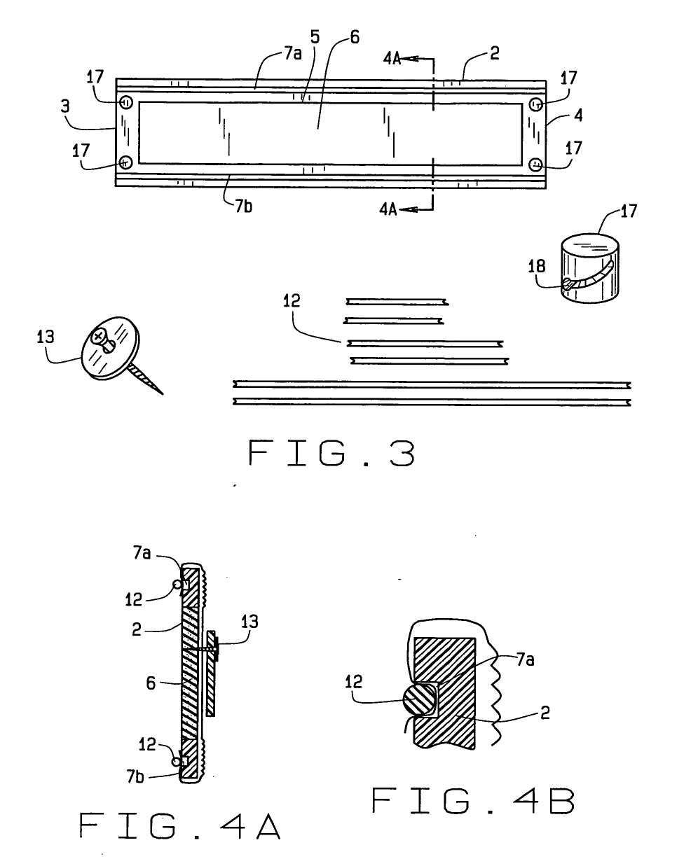

Turning to FIG. 3, the header 2 has a generally rectangular shape with an upright orientation. Parallel to the longitudinal axis, the header 2 has an opening 5 filled with a foam board 6. The opening 5 has a generally rectangular shape within the two parallel spaced apart grooves 7a, 7b. The present invention permits access to the foam board 6 from the interior and the exterior of the invention. Proximate to the left end 3, the header 2 has a pair of spaced apart female locking fittings. The female locking fittings have a location inside of the parallel grooves 7a, 7b. Proximate to the right end, the header 2 has a second pair of spaced apart female locking fittings. The female locking fittings have a generally cylindrical shape with a circumferential slice 18 to accept the male locking pins 16. Upon one end of the cylindrical shape, the female locking fittings 17 have a slot to receive an edge of a coin or screwdriver for turning. Upon turning, a female locking fitting 17 draws tight a male locking pin 16 to secure a strut 8,12 to the header 2.

The present invention includes accessories to mount fabric and decorations. A plurality of washers with screws 13 fastens decorations and fabric to the foam board 6. A screw inserts into a central hole in the round washer 13. The screw has wide threading to grasp the foam board 6 and a slot in the head to permit turning by the same screwdriver as in the female locking fittings 17. Preferably, the washer 13 and screw are plastic. Alternatively, the fasteners 13 can be hook and loop material applied to the foam board 6 and cooperating with decorative items A plurality of foam cords 12 secures fabric to the groove 7a, 7b, 7c, 7d, 7e, 7f, 7g, 7h in the header 2, the left strut 8, and the right strut 12. At a minimum the plurality contains two short cords 12, four medium cords 12, and four long cords 12. The short cords 12 fill the groove 7e, 7h in the left strut 8 and the right strut 12 between the parallel grooves 7c, 7d, 7f, and 7g. The medium cords 12 fill the parallel grooves 7c, 7d, 7f, 7g in the left strut 8 and the right strut 12. The long cords 12 fill the parallel grooves 7a, 7b in the header 2. Generally, each cord 12 has a length similar to that of the groove to be filled. With the cords 12 being handled during use, the plurality includes extra cords 12 in the event of a loss.

FIG. 4A illustrates the connection of fabric and decorations to the cornice frame 1, here through the header 2. Fabric stretches over the exterior face of the header 2 including the foam board 6. The fabric folds over the top and the bottom of the header 2 and across the parallel grooves 7a, 7b, 7c, 7d, 7f, 7g. Pressing the fabric into the grooves 7, a cord 12 placed over the fabric and into the groove 7 secures the fabric to the interior of the header 2. The cord 12 secured in a groove 7a, 7b of the header 2 also applies to the grooves 7c, 7d, 7e, 7f, 7gf, 7h in the left strut 8 and the right strut 12. For decorations, a homeowner places the decoration upon the fabric on the foam board 6, typically towards the exterior of the present invention. With the decoration generally fabric, a homeowner gently inserts a screw through the decoration and into the foam board 6. The homeowner advances the screw until the washer 13 seats firmly against the decoration.

Moving to FIG. 4B, fabric stretches over the exterior face and top of the header 2 in more detail. The fabric folds over the top of the header 2 and across the parallel groove 7a, 7b for example illustrating the connection with all grooves 7. Pressing the fabric into the groove 7a, 7b, a piece of cord 12 placed over the fabric and wedged into the groove 7a, 7b secures the fabric to the interior of the header 2. Friction between the piece of cord 12, fabric, and groove 7 releasably secures the fabric in place upon the header 2.

To utilize the present invention, a homeowner places the male fittings 16 of the left strut 8 into the left end 3 of the header 2 with the male mounting pin 14 up. A homeowner then turns the female locking fitting 17 of the left end 3 with a screwdriver to secure the left strut 8 to the left end 3. The homeowner repeats this with the right strut 12 on the right end 4. Next, the homeowner applies fabric to the present invention 1 with the fabric across the exterior of the present invention 1 top to bottom. Holding fabric over the grooves 7 on the interior of the cornice frame 1, the homeowner emplaces cords 12 in the parallel and upright grooves 7. The homeowner then secures decorations to the foam board 6 using the washers 13 with screws as described in FIG. 4A.

With female mounting hardware or bracket 15 upon a wall above a window, the homeowner grasps the decorated present invention 1 with male mounting pins 14 up and positions the present invention 1 so the male mounting pins 14 fit within a slot 15a of the bracket 15. The homeowner then rests the left strut 8 and the right strut 12 against the wall so the decorated header 2 extends into a room and augments the decor of a room.

From the aforementioned description, a cornice frame has been described. The cornice frame is uniquely capable of rapid assembly by homeowners and securing decorations to a foam board. The cornice frame and its various components may be manufactured from many materials including but not limited to yellow pine, sheet metal, polymers, high density polyethylene HDPE, polypropylene PP, polyvinyl chloride PVC, nylon, polyurethane foam, ferrous and non-ferrous metals, their alloys, and composites.

1. A frame and accessories for decorating above residential windows with fabric and decorative items comprising:
a header having a generally rectangular shape, a left end and an opposite right end, an opening filled with a core, two parallel spaced apart longitudinal grooves bordering said opening;
a left strut having a generally rectangular shape of lesser length than said header, a front end and an opposite back end, two parallel spaced apart grooves coplanar with said grooves in said header, a groove adjacent to said back end connecting said parallel grooves, and means to mount to a wall upon said back end;
a right strut having a generally rectangular shape of lesser length than said header, a front end and an opposite back end, two parallel spaced apart grooves coplanar with said grooves in said header, a groove adjacent to said back end connecting said parallel grooves, and means to mount to a wall upon said back end;
a plurality of foam cords in various lengths; and,
a plurality of fasteners to secure fabric to said core;
wherein said front end of said left strut connects with said left end of said header and said front end of said right strut connects with said right end of said header, said mounting means connects said left strut and said right strut to a wall above a window, and fabric secures over said header, said left strut, and said right strut by said foam cords placed over the fabric into said grooves and decorations secure upon said fabric at said core by said fasteners.

2. The frame of claim 1 wherein said core is foam board fitted to said opening.

3. The frame of claim 2 wherein said opening and said foam board have a rectangular shape.

4. The frame of claim 1 further comprising:
said mounting means having a pin upon said back ends of said left strut and said right strut, said pin defining the top of said frame and a corresponding bracket to receive said pin, said bracket mounted upon a wall proximate to said window.

5. The frame of claim 4 wherein said pin has a rectangular shape with the longitudinal axis of said pin oriented vertically and said bracket has a rectangular opening oriented vertically.

6. The frame of claim 1 further comprising:
said left strut and said right strut connecting to said header with two male fittings upon each of said front ends of said left strut and said right strut and two female fittings upon said left end and said right end of said header.

7. The frame of claim 6 wherein said male fitting is a shaped pin and said female fitting is a cylinder with a helical slice whereby said pin fits into said slice and turning of said female fitting draws tight said pin.

8. The frame of claim 1 wherein said fastener is a washer with a screw through a central hole.
